(19) United States
(12) Patent Application Publication
(10) Pub. No.: US 2010/0166933 A1
(43) Pub. Date: Jul. 1, 2010

(54) Frozen Confectionery and Beverage Products

(75) Inventors: Mark John Berry, Sharnbrook (GB); Andrew Hoddle, Sharnbrook (GB); Ellen Siobhan Mitchell, Vlaardingen (NL); Michael William Pleasants, Sharnbrook (GB)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., D/B/A UNILEVER, Englewood Cliffs, NJ (US)

(21) Appl. No.: 12/639,442

(22) Filed: Dec. 16, 2009

(30) Foreign Application Priority Data
Dec. 29, 2008 (EP) EP08172986
Dec. 29, 2008 (EP) EP08172987

(51) Int. Cl. A23L 1/30; A23G 9/32; A23F 3/00; A23F 5/00; A23G 1/56; A23L 2/52

(52) U.S. Cl. 426/565; 426/590; 426/594; 426/597; 426/593

(57) ABSTRACT

A frozen confection or a beverage product is provided which contains at least 400 mg of theobromine and at least 40 mg of caffeine per 100 grams of the product. Also provided is a frozen confection or a beverage product for the enhancement of mood without transient elevation of blood pressure.

### TECHNICAL FIELD OF THE INVENTION

The present invention relates to frozen confection or beverage products that are mood-enhancing when consumed and to frozen confection or beverage products for the enhancement of mood without transient elevation of blood pressure.

### BACKGROUND TO THE INVENTION

Chocolate and chocolate products are believed to be mood enhancing. Part of the reason may be the pleasant taste that can help to make consumers feel happy. Additionally, chocolate contains substances that, when consumed in sufficient quantity, are psycho-pharmacologically active (Smit et al., Psychopharmacology 2004, 176, pp 412-419). In particular caffeine (1,3,7-trimethylxanthine) and theobromine (3,7-dimethylxanthine) are known to affect the mood when ingested, and additionally have other beneficial effects like improved brain function, higher alertness and appetite suppression. It would be appealing to many consumers to eat a food product to enhance their mood rather than, for example, to take prescription medicines. Typically, cocoa powder comprises approximately 2 wt % theobromine and 0.2% caffeine. However, these amounts are too low to have a substantial effect on mood states at the normal levels of cocoa solids found in most food products. Therefore there is a desire to enrich food products with caffeine and theobromine in order to achieve the beneficial effects of these compounds when consumed as ingredients of a food product. For example, WO 2007/042745 discloses chocolate based appetite suppressants containing enhanced amounts of theobromine.

Caffeine is well-known for its effect on mental states. However, caffeine is also known to cause a transient but significant increase in blood pressure. Furthermore, both caffeine and theobromine have an intrinsically bitter taste. It is therefore desirable to provide products which have the mood enhancing effects of both theobromine and caffeine, but without the latter's unwanted effect on blood pressure and without the bitter taste.

### BRIEF DESCRIPTION OF THE INVENTION

We have now found that it is possible to provide a food product containing elevated amounts of theobromine and caffeine. Accordingly, in a first aspect the present invention provides a frozen confection or a beverage product which contains at least 400 mg of theobromine and at least 40 mg of caffeine per 100 grams of the product. Surprisingly, we have found that theobromine can counteract the transient elevation in blood pressure which arises from the consumption of caffeine. “Transient elevation” as used herein refers to the increase in blood pressure which occurs within 3 hours of consuming caffeine.

In one embodiment of the present invention the products are frozen confections. The present inventors have recognised that a frozen confection such as ice cream is an especially suitable type of mood-enhancing food product. For example, ice cream has been shown to have an effect on the orbitofrontal cortex, a part of the brain that is known to activate when people enjoy themselves (see for example “The Guardian”, Apr. 29, 2005). In addition, we have found that frozen confection products containing high levels of theobromine and caffeine are more palatable than chocolate containing similar amounts of theobromine and caffeine. In a further embodiment the food products according to the present invention are preferably beverages. We have also found that beverages containing high levels of theobromine and caffeine are palatable.

The products according to the present invention preferably comprise a total amount of at least 500 mg of theobromine, more preferably at least 600 mg, most preferably at least 700 mg per 100 g of the product.

The products according to the present invention preferably comprise a total amount of at least 50 mg of caffeine, more preferably at least 70 mg, most preferably at least 100 mg per 100 g of the product.

Preferably the ratio of the amounts of theobromine and caffeine is at least 3:1, more preferably at least 5:1.

Products of the present invention preferably comprise cocoa solids, for example in a chocolate or chocolate analogue or in the form of cocoa nibs. Theobromine and caffeine are naturally present in cocoa solids in the preferred ratios. Products which contain enhanced amounts of substances which are naturally present are generally more appealing to consumers, and moreover the intrinsic bitter taste of caffeine and theobromine is expected in products which contain cocoa solids.

Preferably the product comprises from 25 to 45 wt % of a chocolate or chocolate analogue.

Preferably the product comprises from 5 to 20 wt % of cocoa nibs.

Where products of the present invention are beverages, they are preferably tea-based beverages, coffee-based beverages or cocoa-based beverages. Cocoa-based beverages according to the invention may comprise cocoa powder, chocolate and cocoa nibs.

The portion size of the products of the present invention is preferably at most 500 g, more preferably at most 250 g and more preferably still at most 125 g. The portion size is at preferably least 50 g, more preferably at least 65 g and more preferably still at least 75 g

In a further aspect, the present invention provides a frozen confection or a beverage product comprising at least 400 mg of theobromine and at least 40 mg of caffeine per 100 grams of the product for the enhancement of mood without transient elevation of blood pressure.

### DETAILED DESCRIPTION OF THE INVENTION

All percentages, unless otherwise stated, refer to the percentage by weight, with the exception of percentages cited in relation to the overrun.

The term “frozen confection” means an edible confection made by freezing a mix of ingredients which includes water. Frozen confections typically contain fat, non-fat milk solids and sugars, together with other minor ingredients such as stabilisers, emulsifiers, colours and flavourings. Frozen confections include ice cream, water ice, frozen yoghurt and the like.

Products consisting of chocolate-flavoured ice cream coated with chocolate or a chocolate analogue have been known for many years. The term “chocolate” as used herein includes dark chocolate and milk chocolate. The term “chocolate analogue” means chocolate-like fat-based confectionery compositions made with fats other than cocoa butter (for example cocoa butter equivalents, coconut oil or other vegetable oils). Such chocolate analogues are sometimes known as “couvertures”. Chocolate analogues need not conform to standardized definitions of chocolate which are used in many countries. In addition to fat and cocoa solids, chocolate and chocolate analogues may contain milk solids, sugar or other sweeteners and flavourings. These products contain some theobromine and caffeine both from the cocoa solids which are used to flavour the ice cream and from the cocoa solids used in the coating. The quantities of theobromine and caffeine in a chocolate-flavoured ice cream can be estimated by adding the contribution from each ingredient using the values given in chapter 10 of “Chocolate and Cocoa” Ed. Knight, Blackwell Science Ltd. (1999). Cocoa mass (=chocolate liquor) contains about 1.22% theobromine and 0.21% caffeine. Cocoa nibs have the same composition as cocoa mass. The term “cocoa nibs” means small particles of cocoa bean. They are produced by drying cocoa beans, breaking them and then removing the pieces of shell. The remaining pieces of the cocoa bean kernel are known as cocoa nibs. Nibs are typically particles of about 2-7 mm in size, such as about 3 mm. Cocoa powder contains 1.89-2.69% theobromine and 0.16-0.31% caffeine. Using this method, we have estimated that conventional chocolate ice creams contain about 70 mg theobromine and 3 mg of caffeine per 100 grams of ice cream.

The quantities can also be analytically determined by removing fat from the sample and analysing by HPLC. For example, Craig et al. (Journal of Food Science, vol. 49, January 1984, p. 302-303) reported theobromine and caffeine levels in chocolate ice cream of 62 mg and 3.2 mg per 100 g of ice cream respectively.

The maximum amount of cocoa powder that can be used in frozen confections, such as chocolate-flavoured ice cream, is about 12 wt %. If greater amounts of cocoa powder are used, the unfrozen mix becomes very viscous, and hence difficult to process, and in particular, difficult to aerate. This results in a hard, dense and unpleasant frozen confection. Similarly, the maximum amount of cocoa powder that can be used in the chocolate/chocolate analogue is about 25%. This is because the fat content of the chocolate/chocolate analogue must be at least 45% in order for it to be sufficiently fluid so that it is suitable for coating ice creams, and the sugar content must be at least about 30% so that it has an acceptable taste.

Chocolate-flavoured ice creams that are coated with dark chocolate or that contain cocoa nibs can contain somewhat higher levels of theobromine and caffeine than standard chocolate ice creams.

Of the commercially available ice cream products that the present inventors have investigated, Magnum™ Essence contains the highest levels of theobromine and caffeine. This product is a chocolate ice cream coated with chocolate and containing a dark chocolate core. Using HPLC (as described in example 1 below) it was found to contain a total of approximately 320 mg theobromine and 30 mg caffeine per 100 grams.

Certain beverages, such as cocoa-based beverages also contain low levels of theobromine and caffeine. However these beverages do not contain levels high enough to achieve the beneficial effects of these compounds. Other beverages, such as tea- and coffee-based drinks also do not have sufficiently high levels of theobromine.

The products of the present invention contain higher amounts of theobromine and caffeine than previously known products. The source of the theobromine and caffeine in the present invention may be any natural or synthetic source. The theobromine and/or caffeine added to the frozen confection may be from a synthetic source. For example caffeine and theobromine can be bought in pure form. The theobromine and/or caffeine may also originate from a natural source, for example a cocoa extract containing a relatively high concentration of caffeine and theobromine. Any other source of theobromine and/or caffeine may be suitable as well.

The products of the present invention are preferably aerated, i.e. they have an overrun of more than 20%, preferably more than 50%, more preferably more than 75%. Preferably the products have an overrun of less than 200%, more preferably less than 150%, most preferably less than 120%. Overrun is defined by equation as follows and is measured at atmospheric pressure

$$overrun \% = \frac{density of mix - density of frozen confection}{density of frozen confection} \times 100$$

The frozen confection products of the invention preferably contain cocoa solids, for example chocolate-flavoured ice cream. Frozen confection products according to the invention may contain, in addition to the frozen confection (e.g. ice cream), other sources of cocoa solids, and hence theobromine and caffeine. In one embodiment, the frozen confection product of the invention contains a chocolate or chocolate analogue and/or cocoa nibs. The chocolate or chocolate analogue may be included in the frozen confection product in any suitable form, such as a coating on the frozen confection, as pieces (inclusions) located within the frozen confection, or as a sauce, e.g. a ripple or swirl in the frozen confection. Preferably the chocolate or chocolate analogue constitutes from 20 to 60% (by weight) of the frozen confection product, more preferably from 25 to 45%. Cocoa nibs may be incorporated into the frozen confection or into the chocolate/chocolate analogue or both. The nibs are preferably present in an amount of from 5 to 20% by weight of the product, more preferably from 10 to 15%. We have found that if higher amounts of nibs are used, the nibs remain in the mouth after the frozen confection has melted and has been swallowed. The resulting mass of nibs is chewy, mouth-drying and difficult to break-down, resulting in an unpleasant and unacceptable sensory experience.

In addition, beverage products according to the invention (e.g. cocoa-based beverages) may also contain other sources of cocoa solids, and hence theobromine and caffeine.

The present invention will now be further described with reference to the following non-limiting examples.

### Example 1

A chocolate-flavoured ice cream mix was made using the ingredients shown in Table 1.

TABLE 1

| Ingredient | Amount (wt %) |
|---|---|
| Cocoa powder 10/12 | 12.0 |
| Butterfat | 8.0 |
| Glucose syrup (63DE 78% solids) | 5.0 |
| Sucrose | 11.0 |
| Skim milk powder | 9.5 |
| Stabiliser | 0.156 |
| Emulsifier | 0.30 |
| Water | To 100 |

The mix was frozen and aerated in a Technohoy MF75 freezer to a temperature of approx −5° C. and an overrun of approximately 60%. The frozen ice cream was collected and cocoa nibs (Nibs-S-473 from Barry-Callebaut) were added at 9.0% (225 g cocoa nibs made up to 2500 g with mix). Samples were collected into 500 ml cartons and hardened at −32° C. in a blast freezer. After hardening, the blocks were cut into pieces which weighed 17 g (approx 27 ml). The products were coated in a chocolate coating containing 15% cocoa nibs, whose composition is given in Table 2. The amount of coating was determined by weighing and was found to be 13.3 g of coating per 17 g of ice cream.

TABLE 2

| Ingredient | Amount (wt %) |
|---|---|
| Sucrose | 34.4 |
| Cocoa butter | 11.1 |
| Butter oil | 10.6 |
| Cocoa mass | 28.5 |
| Soya lecithin | 0.43 |
| Cocoa nibs | 15.0 |

Thus the product consisted of 51% ice cream, 37% chocolate and 12% nibs. The theobromine and caffeine contents were determined by HPLC analysis as follows. The frozen samples were ground. Next, the fat was removed by extraction 3 times with petroleum spirit. The de-fatted samples were then analysed using a Phenyl Hexyl 250×4.6 id mm 5μ HPLC column (mobile phases: A=10% acetonitrile, 0.5% acetic acid. B=100% acetonitrile). The theobromine and caffeine contents were found to be 500 mg and 40 mg per 100 gram of product respectively. The frozen confection product contained only natural sources of caffeine and theobromine

Products were tasted by an informal panel. None of the samples were considered to taste bitter, despite the high levels of caffeine and theobromine. All of the tasters considered the products to be acceptable sensorially. Because of the size of the nibs (approximately 3 mm), only a relatively small amount were bitten into when the product was consumed. Most were swallowed whole, so that the bitterness of the cocoa was mostly not perceived. The nibs provided an interesting textural contrast with the ice cream which may also have distracted the tasters from any bitterness of the product.

### Example 2

An ice cream mix was made using the ingredients shown in Table 3.

TABLE 3

| Ingredient | Amount (wt %) |
|---|---|
| Skim milk powder | 9.29 |
| Refined coconut oil | 10.81 |
| Sucrose | 13.47 |
| Glucose syrup (63DE 78% solids) | 4.52 |
| Cocoa powder 10/12 | 1.00 |
| Theobromine | 0.60 |
| Caffeine | 0.10 |
| Emulsifier | 0.34 |
| Stabiliser | 0.36 |
| Vanilla flavour | 0.01 |
| Water | To 100 |

The mix was split into 2 parts. The first part was frozen in pots and then cut into products of 70 g (approx 65 ml). The products were coated in a chocolate coating (A) whose composition is given in Table 4. The pickup weight of the coating was 27 g per 70 g of ice cream.

Cocoa nibs (Nibs-S-473 from Barry-Callebaut) were added to the second part of the mix at 8.0 wt % (32.0 g cocoa nibs made up to 400 g with mix). This was frozen in pots and then cut into products of 70 g (approx 65 ml). The products were coated in a coating B, which was prepared by stirring 10% cocoa nibs into 90% of coating A (see Table 4). The weight of coating B was 30 g per 70 g of ice cream.

TABLE 4

| Ingredient | A | B |
|---|---|---|
| Sucrose | 40.5 | 36.5 |
| Cocoa butter | 13.0 | 11.7 |
| Butter oil | 12.5 | 11.3 |
| Cocoa mass | 33.5 | 30.2 |
| Soya lecithin | 0.50 | 0.45 |
| Cocoa nibs | — | 10.0 |

The products were analysed as described in Example 1. The ice cream and chocolate coating without nibs contained 450 mg theobromine and 120 mg caffeine per 100 g product. The ice cream and chocolate coating with nibs contained 470 mg theobromine and 94 mg caffeine per 100 g of product.

The products were tasted informally and were found to be quite bitter, but were acceptable, especially to tasters who regularly consumed dark chocolate.

### Example 3

A taste-test was carried out to compare the palatability of a portion of a frozen confection product according to the invention with a portion of a chocolate product comprising similarly high levels of caffeine and theobromine. The portion of frozen confection product contained 65 g of high-cocoa chocolate ice cream, which also contained chocolate nibs, and was coated with 43 g of chocolate and nibs. This frozen confection product contained 477 mg of theobromine and 70 mg of caffeine per 108 g portion. The comparative example was a 50 g portion of “Green and Blacks” 85% cocoa chocolate bar which contained 424 mg theobromine and 62 mg caffeine. 10 volunteers were asked to consume the portion of the frozen confection product and the portion of the chocolate product on separate days. Only 50% of the volunteers were able to eat the whole portion of chocolate due to the very bitter taste of the high cocoa chocolate. Conversely, 90% of the volunteers ate the whole portion of the frozen confection product. In addition, 100% of the volunteers rated the taste of the portion of the frozen confection product as “acceptable” or “highly acceptable”. The results of this taste test demonstrate that a frozen confection product according to the invention is more palatable and acceptable to consumers than a portion of chocolate containing similar amounts of theobromine and caffeine.

### Example 4

A human study was carried out using a randomised, double-blind, crossover design to compare the effects of theobromine and caffeine on mood and on blood pressure. Volunteers consumed one of 4 treatments: theobromine only, caffeine only, theobromine and caffeine combined or placebo. The amount of theobromine in the treatment was 700 mg; the amount of caffeine was 120 mg; thus the ratio (5.8:1) was consistent with that found in chocolate and cocoa and cocoa beans. Theobromine was pharmaceutical grade, supplied by Fagron, Netherlands. All treatments were given in the form of a gelatine capsule, filled with the active. The placebo capsules matched in appearance and were filled with Avicel (microcrystalline cellulose). The gelatin capsules (size 1) were supplied by Blockland Medical supplies and meet European Pharmacopoeia (Ph. Eur) standards. Mood was assessed by emotion responses to questionnaires (Bond and Lader, 1974). Twenty-four healthy volunteers took part and arrived at the laboratory having consumed a standard lunch and having abstained from theobromine- and caffeine-containing foods such as chocolate for 12 hours. At the start of each session, participants answered a baseline set of questionnaires, which took approximately 15 minutes to complete. On completion, they were given a 10 minute break in which to consume the capsules. The questionnaire was repeated 1, 2 and 3 hours after ingestion. Blood pressure was measured at 0, 1 and 3 hours after treatment. Participants were allowed to read quietly between test batteries. The results are given in Tables 5 and 6.

TABLE 5
Alertness score in Bond-Lader test

| | Time zero | 1 hour | 2 hours | 3 hours |
|---|---|---|---|---|
| Placebo | 0 | −0.07 | −0.07 | 0 |
| Caffeine | 0 | +0.01 | +0.05 | +0.07 |
| Theobromine | 0 | −0.06 | −0.03 | −0.01 |
| Caffeine + | 0 | +0.01 | +0.03 | +0.03 |
| Theobromine | | | | |

TABLE 6
Change in systolic blood pressure (Hgmm)

| | Time zero | 1 hour | 3 hours |
|---|---|---|---|
| Placebo | 0 | +5 | 0 |
| Caffeine | 0 | +10 | −3 |
| Theobromine | 0 | +3 | +4 |
| Caffeine + | 0 | +5 | +2 |
| Theobromine | | | |

The results show that the combination of theobromine+caffeine delivers an increase in alertness without the rise in systolic blood pressure (significantly higher than placebo) after 1 hour that results from a treatment of caffeine only.

### Example 5

A further human study was carried out using a double-blind, crossover, randomised, placebo-controlled experiment design to compare the effects of different levels of theobromine and caffeine on mood and on blood pressure. Volunteers consumed one of 3 treatments: placebo, low dose (300 mg theobromine+40 mg caffeine) and high dose (450 mg theobromine+60 mg caffeine). Volunteers were required to abstain from all food and drinks containing caffeine or theobromine from 8:00 pm on the previous night and ate a standardized light meal at home. The study took place in the afternoon. Acute effects of the three treatments were tested over a period of three weeks with a separation of 1 week between the treatments. Volunteers' self-reported mood was assessed by emotion responses to questionnaires (Bond and Lader, 1974) and was measured 1 and 2 hrs post-treatment.

Post-treatment measurements of mood were statistically modelled as a linear function of the corresponding baseline measurement and different treatments taking into account inter-participant variability (Tables 7 and 8). An increase in alertness was observed at both 1 and 2 hrs post-treatment for the low and high dose treatments. A similar linear trend of increase in calmness was observed.

TABLE 7
Alertness score in Bond-Lader test

| | 1 hour | 2 hours | Overall change |
|---|---|---|---|
| Placebo | 0.79 | 0.78 | −0.01 |
| Low dose | 0.80 | 0.82 | +0.02 |
| High dose | 0.82 | 0.83 | +0.01 |

TABLE 8
Calmness score in Bond-Lader test

| | 1 hour | 2 hours | Overall change |
|---|---|---|---|
| Placebo | 0.83 | 0.81 | −0.02 |
| Low dose | 0.82 | 0.83 | +0.01 |
| High dose | 0.84 | 0.85 | +0.01 |

Blood pressure was measured before and 1 hr post-treatment (Table 9). An increase in systolic blood pressure was observed at 1 hr after both the low dose treatment and high dose treatment. However, the increase in systolic blood pressure after the high dose treatment was less than that caused by the low dose even though the high dose treatment contained 50% more caffeine than the low dose.

TABLE 9
Change in systolic blood pressure (Hgmm)

| | Time zero | 1 hour | Overall change |
|---|---|---|---|
| Placebo | 111 | 115 | +4 |
| Low dose | 112 | 121 | +9 |
| High dose | 113 | 121 | +8 |

These results further show that the combination of theobromine+caffeine delivers an increase in alertness and calmness yet even when the amount of caffeine is increased by 50% in the high dose treatment the rise in systolic blood pressure is attenuated by the increased levels of theobromine.

### Example 6

A cordial-based beverage was made as follows: 20 ml of blackcurrant cordial was diluted in 80 ml of water to which 700 mg of theobromine and 70 mg of caffeine were added.

### Example 7

A cocoa-based beverage, in the form of a drinking chocolate, was made as follows: A batch of drinking chocolate was prepared by mixing 240 g sugar, 40 g fat-reduced cocoa and 1940 g whole milk. A 100 ml aliquot of the drinking chocolate was taken from the batch and 700 mg of theobromine and 70 mg of caffeine were added to the aliquot. The beverage was tasted by an informal panel. It was not considered to taste bitter, despite the high levels of caffeine and theobromine, and all the tasters considered the product to be highly acceptable.

The various features and embodiments of the present invention, referred to in individual sections above apply, as appropriate, to other sections, mutatis mutandis. Consequently features specified in one section may be combined with features specified in other sections, as appropriate.

1. A frozen confection or a beverage product which contains at least 400 mg of theobromine and at least 40 mg of caffeine per 100 grams of the product.

2. A product according to claim 1 which comprises at least 500 mg of theobromine per 100 g of the product.

3. A product according to claim 1 which comprises at least 50 mg of caffeine per 100 g of the product.

4. A product according to claim 1 wherein the ratio of the amounts of theobromine and caffeine is at least 3:1.

5. A product according to claim 1 wherein the product is a frozen confection.

6. A product according to claim 5 which comprises cocoa solids.

7. A product according to claim 5 which comprises a chocolate or chocolate analogue.

8. A product according to claim 5 which comprises cocoa nibs.

9. A product according to claim 1 wherein the product is a beverage.

10. A product according to claim 9 wherein the beverage is tea-based or coffee-based.

11. A product according to claim 9 wherein the beverage is cocoa-based.

12. A product according to claim 1 wherein the product has an overrun of at least 50%.

13. A product according to claim 1 in a portion size of from 50 g to 500 g.

14. A product according to claim 1 for the enhancement of mood without transient elevation of blood pressure.
